(19) United States
(12) Patent Application Publication
(10) Pub. No.: US 2013/0087426 A1
(43) Pub. Date: Apr. 11, 2013

(54) Accessory Drive for a Mulitple Engine Powertrain

(71) Applicant: ECOMOTORS, INC., Allen Park, MI (US)

(72) Inventor: Dale A. Gage, Dearborn Heights, MI (US)

(73) Assignee: ECOMOTORS, INC., Allen Park, MI (US)

(21) Appl. No.: 13/623,657

(22) Filed: Sep. 20, 2012

Related U.S. Application Data
(60) Provisional application No. 61/543,347, filed on Oct. 5, 2011.

(51) Int. Cl. F16D 13/58

(52) U.S. Cl. 192/112

(57) ABSTRACT

An engine system providing exceptional fuel efficiency is one that has two powerplants coupled by an electrically-actuated clutch. Packaging the two powerplants, the clutch, and the engine accessories presents a challenge. By driving the accessories via a shaft associated with the clutch, the accessories can be mounted between the two engines. Furthermore, this may facilitate providing one of each accessory rather than one per engine. The housing of the clutch is provided with tabs extending outwardly on which the accessories and associated components, such as mounting plates, mounting brackets, shafts, idler pulleys, tensioners, and pulleys, are mounted.

### CROSS REFERENCE TO RELATED APPLICATIONS

The present application claims priority benefit from U.S. provisional patent application No. 61/543,347 filed 5 Oct. 2011.

### FIELD

The present disclosure relates to an accessory drive for a multiple powertrain system.

### BACKGROUND

A powertrain system that provides superior fuel efficiency is one that includes two internal combustion engines that are coupled via a clutch. At most operating conditions, power is provided by one of the engines. When demanded power level exceeds what the operating engine can provide, the second engine is commanded to also operate. In one scenario, one of the two engines is the primary engine which is the engine that provides the driving power with the secondary engine operated only as needed. In another scenario, either of the two engines can serve as the primary engine, i.e., the engine operated at low power requirements. This is advantageous to ensure equal wear on the two engines so that the powertrain system has longer operational life. A simple way of accomplishing this is to motor the non-operating engine. Alternatively, a gear set, such as is common in hybrid electric vehicles, can be arranged to allow the power from either engine to provide the driving power.

In any of the scenarios, a compact apparatus to drive accessories, such as the alternator, power steering pump, air conditioner, water pump, and brake booster, is desired. Furthermore, it is desirable to provide one of each accessory rather than two, i.e., one coupled to each powerplant.

### SUMMARY

An accessory drive for a powertrain system having two powerplants includes a clutch that selectively couples the two powertrains via first and second selectively-coupled portions. The clutch is provided with a plurality of mounting tabs extending outwardly substantially in a radial direction from a housing of the clutch. The housing of the clutch includes a plurality of sections each having a flange with the housing sections coupled at the flanges and at least one of the mounting tabs extends outwardly from one of the flanges. In one embodiment, a first mounting tab defines a journal providing a bearing surface to support a shaft associated with an accessory drive pulley and a second mounting tab defines mounting holes to which an accessory support member is coupled. In another embodiment, at least one mounting tab extends from a first end of the clutch housing proximate the first powerplant and at least one mounting tab extends from a second end of the clutch housing proximate the second powerplant.

In some embodiments, the first portion of the clutch has a clutch shaft that is coupled with a crankshaft of the first powerplant. An accessory drive shaft has an axis of the accessory drive shaft substantially parallel with the clutch shaft. The clutch shaft and the accessory drive shaft have teeth that engage with a chain linking the shafts in a defined rotational relationship. The system may further include a pulley coupled to the accessory drive shaft, a plate mounted to at least one of the mounting tabs, an accessory mounted to the plate with the accessory having a pulley, and a belt wrapped around the pulley associated with the accessory drive shaft and the pulley associated with the accessory. The accessory may be a steering power pump, an alternator, or a water pump. The system may further include a belt tensioner having a pulley. The belt is further wrapped around the pulley associated with the belt tensioner coupled to the accessory drive shaft wrapped around the first pulley coupled to the accessory drive shaft wrapped around the second pulley mounted to at least one of the mounting tabs mounted to the first plate with the first accessory having a pulley onto which the second belt is further wrapped, and a second accessory having a pulley onto which the second belt is further wrapped.

Also disclosed is a clutch having a first housing portion with a first flange extending therefrom substantially radially, a second housing portion with a second flange extending therefrom substantially radially, and first and second mounting tabs extending outwardly from one of the first and second flanges. The first mounting tab defines a journal providing a bearing surface adapted to support a rotatable shaft and the second mounting tab defines mounting holes adapted to support an accessory device. At least one additional mounting tab extends outwardly substantially radially proximate an end of the clutch in some embodiments. The clutch is adapted to couple to first and second powertrains and the clutch selectively couples the first powerplant to the second powerplant. Also disclosed is a powertrain system has a first powerplant, a second powerplant, a clutch coupled between the first powerplant and the second powerplant, and a plurality of mounting tabs extending outwardly substantially in a radial direction from a housing of the clutch wherein a first mounting tab defines a journal providing a bearing surface to support a shaft associated with an accessory drive pulley and a second mounting tab has mounting holes to which an accessory support member is coupled. A clutch shaft extends axially from the clutch. An accessory drive shaft with an axis of the accessory drive shaft is substantially parallel with the central axis of the clutch. The accessory drive shaft rotates within the bearing surface in the first mounting tab and a flexible member couples the accessory drive shaft. The system may further include a drive pulley coupled to the accessory drive shaft, a first accessory coupled to the second mounting tab wherein the first accessory has an accessory pulley, and a belt coupling the drive pulley and the accessory pulley.

In one embodiment, the system includes a clutch shaft extending axially from the clutch and an accessory drive shaft with an axis of the accessory drive shaft substantially parallel with the central axis of the clutch. The system includes a first overrunning clutch coupled to one end of the accessory drive shaft, a second overrunning clutch coupled to the other end of the accessory drive shaft, a first flexible member coupling the accessory drive shaft with the first overrunning clutch, and a second flexible member coupling the accessory drive shaft with the second overrunning clutch. A drive pulley is coupled to the accessory drive shaft. A first accessory is coupled to the second mounting tab. The first accessory has an accessory pulley and a belt couples the drive pulley and the accessory pulley.

By providing the accessory drive components between the two powerplants, the system can be packaged compactly and the system may be provided with a single accessory that can be used to satisfy both engines and/or a vehicle into which the engine system is provided.

### BRIEF DESCRIPTION OF THE DRAWINGS

FIGS. 1 and 2 are isometric representations of a multiple powerplant system according to an embodiment of the disclosure; and

FIGS. 3 and 4 are schematic representations of multiple powerplant systems.

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

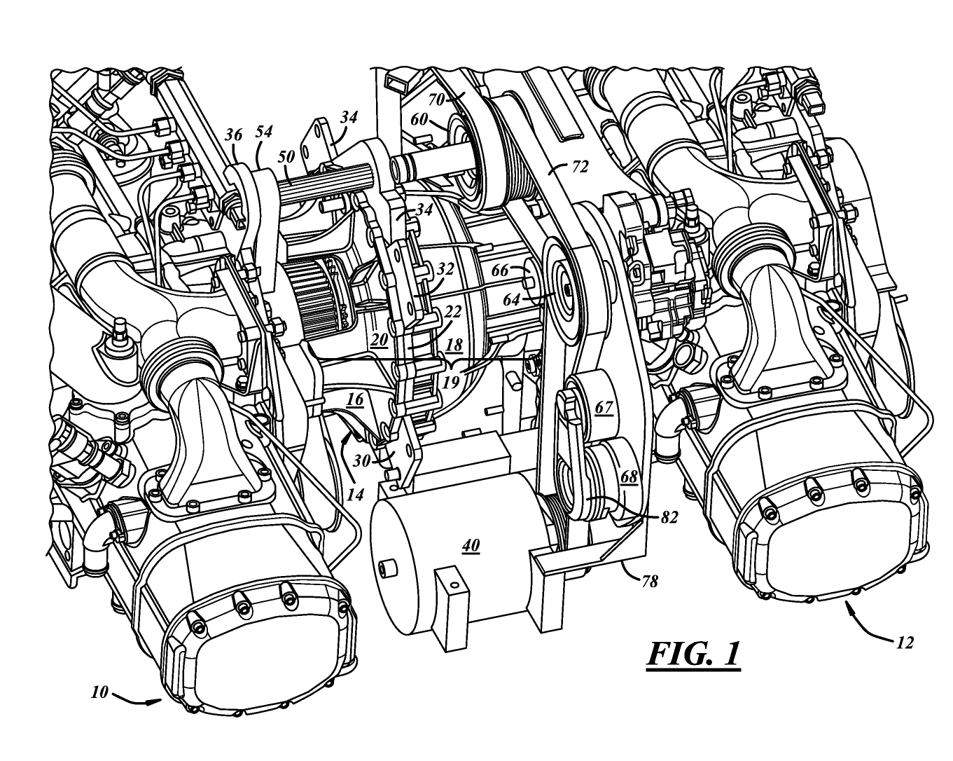

A powertrain system according to an embodiment of the disclosure is shown in FIG. 1. A primary engine 10 is selectively coupled to a secondary engine 12 via an electronically-controlled clutch (ECC) 14. Engines 10 and 12 are opposed-piston, opposed-cylinder engines such as disclosed in U.S. Pat. No. 6,170,443. The present disclosure, however, applies to any type of powerplant. Furthermore, the primary and secondary powerplants may be of different types and/or sizes.

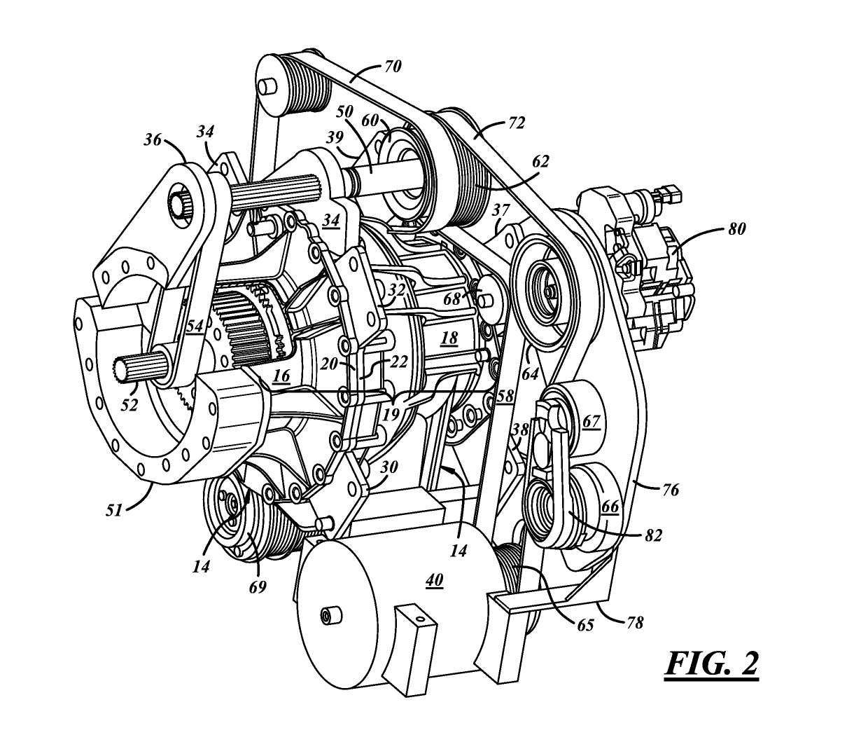

Referring now to FIGS. 1 and 2, the housing 19 of clutch 14 includes at least two housing portions 16 and 18. Housing portion 16 has a flange 20 that is coupled to a flange 22 of housing portion 18. Flange 22 has a plurality of mounting tabs 30, 32, and 34 extending outwardly (radially) from clutch 14. Tab 30 has two orifices; to one of which an alternator 40 is mounted.

Housing portion 16 is extended axially on an end proximate primary powerplant 10, shown as extension 52 in FIG. 2. Such extension 51 is provided to house an extended shaft 51 on clutch 14. Shaft 52 is extended axially to allow for a sprocket portion on shaft 52 to couple with a chain, discussed further below. In regards to the extension 51 and extended shaft 52, these are extended in relation to a prior art clutch in which there is no power takeoff to drive ancillaries.

A tab 36 extends outwardly from the end of clutch 14. Tabs 34 and 36 each have a journal through which a shaft 50 extends. In FIG. 2, a shaft 52 extends axially out of clutch. A belt 54 meshes with sprockets associated with shafts 50 and 52. Shaft 50 is driven via shaft 52 of clutch 14. Pulleys 60 and 62 are coupled to shaft 50. Belts 70 and 72 are wrapped around pulleys 60 and 62, respectively.

On the end of clutch 14 proximate secondary powerplant 12 are yet more mounting tabs 37-39 (visible in FIG. 2; mostly occluded in the view of FIG. 1). A plate 76 mounts to tabs 37 and 38 as well as to a bracket 78 mounted to alternator 40. A pulley 64 coupled to a power steering pump 80 also has belt 72 wrapped around. Belt 72 wraps is also wrapped around pulley 65 of alternator 40, idler pulley 66, and pulley 67 of belt tensioner 82. Belt 70 engages with pulleys of other accessories (not shown).

When primary powerplant 10 rotates, shaft 52 is caused to rotate. Via belt 54, shaft 50, along with pulleys 60 and 62, rotates. Via belt 72, power steering pump 80, and alternator 40 also rotate. Similarly, pulley 60, via belt 70, may drive additional accessories that are not shown in FIGS. 1 and 2.

Elements 54, 70, and 72 are shown as belts in FIGS. 1 and 2, but are not intended to be limiting. These may be chains or belts or any other suitable flexible member to engage with the pulleys.

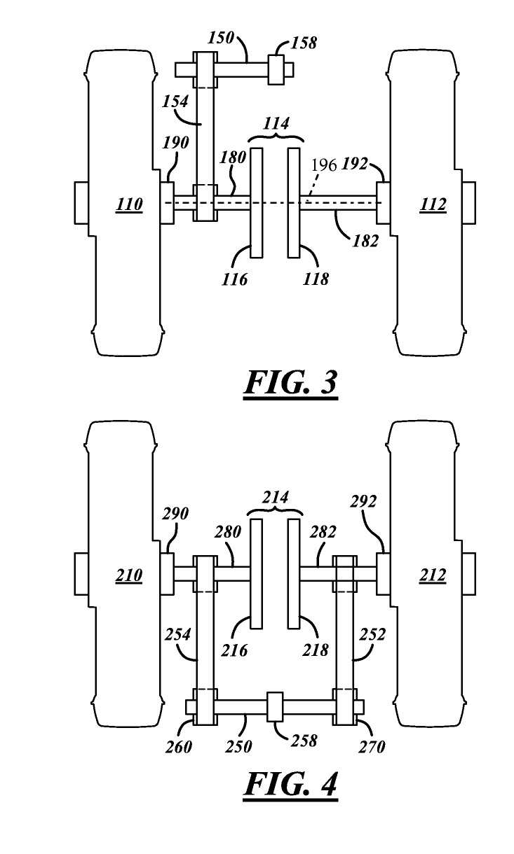

In FIG. 3 a schematic is shown in which primary powerplant 110 is coupled to a first portion 116 of clutch 114 and secondary powerplant 112 is coupled to a second portion 118 of clutch 114. As shown in FIG. 3, first and second portions 116 and 118, shown as plates, are not touching and thus primary powerplant 110 may be rotating independently of secondary powerplant. When plates 116 and 118 are pressed together, powerplants 110 and 112 rotate together. Output from primary powerplant 110 is transmitted through transmission 120. When plates 116 and 118 are engaged, output from both powerplants 110 and 112 is transmitted through transmission 120. Also shown schematically in FIG. 3, is a chain 154 coupled to first portion 116. Chain 154 drives shaft 150 which in turn drives accessories. In such an arrangement, powerplant 110 serves as the primary powerplant.

In FIG. 3, a central axis 196 of clutch 114 is shown. In some embodiments, mounting tabs are described as being extending radially. The radial direction is taken with respect to central axis 196.

In FIG. 4, a schematic is shown in which either of powerplants 210 or 212 may be the primary powerplant. When clutch 214 is disengaged, as shown in FIG. 4, if powerplant 210 is rotating, chain 254 that meshes with shaft 280 associated with clutch portion 216 also moves. Chain 254 engages with overrunning clutch 260 that is coupled to accessory shaft 250. Analogously, crankshaft 292 of powerplant 212 is coupled to clutch portion 218 via shaft 282. Chain 252 engages with overrunning clutch 262 that is also coupled to accessory shaft 250. Accessory shaft 250 has a pulley 258 by which accessories can be driven.

When powerplant 210 rotates and powerplant 212 is stationary, overrunning clutch 260 is engaged with shaft 250, but overrunning clutch 262 is disengaged with shaft 250 so that shaft 250 can rotate while chain 252 and powertrain 212 remain stationary. Or, if both powerplants 210, 212 are rotating, the powerplant that is rotating at a higher speed actually drives shaft 250 via its respective overrunning clutch with the overrunning not engages with shaft 250. With such a configuration, shaft 250 rotates when either powerplant rotates.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

I claim:

1. A powertrain system, comprising:
a first powerplant;
a second powerplant;
a clutch having a first portion and a second portion, the first and second portions are selectively-coupled, the first powerplant is coupled to the first portion of the clutch, and the second powerplant is coupled to the second portion of the clutch; and
a plurality of mounting tabs extending outwardly substantially in a radial direction from a housing of the clutch.

2. The system of claim 1 wherein the housing of the clutch is comprised of a plurality of sections each having a flange with the housing sections coupled at the flanges and at least one of the mounting tabs extends outwardly from one of the flanges.

3. The system of claim 1 wherein a first mounting tab defines a journal providing a bearing surface to support a shaft associated with an accessory drive pulley and a second mounting tab defines mounting holes to which an accessory support member is coupled.

4. The system of claim 1 wherein at least one mounting tab extends from a first end of the clutch housing proximate the first powerplant and at least one mounting tab extends from a second end of the clutch housing proximate the second powerplant.

5. The system of claim 1 wherein the first portion of the clutch has a clutch shaft that is coupled with a crankshaft of the first powerplant the system further comprising:
an accessory drive shaft with an axis of the accessory drive shaft substantially parallel with the clutch shaft wherein the clutch shaft and the accessory drive shaft have teeth; and
a chain linking the clutch shaft and the accessory drive shaft in a defined rotational relationship.

6. The system of claim 5, further comprising:
a pulley coupled to the accessory drive shaft;
a plate mounted to at least one of the mounting tabs;
an accessory mounted to the plate with the accessory having a pulley; and
a belt wrapped around the pulley associated with the accessory drive shaft and the pulley associated with the accessory.

7. The system of claim 6 wherein the accessory is one of a steering power pump, an alternator, and a water pump.

8. The system of claim 6, further comprising:
a belt tensioner having a pulley wherein the belt is further wrapped around the pulley associated with the belt tensioner coupled to the accessory drive shaft; wrapped around the first pulley coupled to the accessory drive shaft; wrapped around the second pulley mounted to at least one of the mounting tabs mounted to the first plate with the first accessory having a pulley onto which the second belt is further wrapped; and
a second accessory having a pulley onto which the second belt is further wrapped.

10. A clutch, comprising:
a first housing portion with a first flange extending therefrom substantially radially;
a second housing portion with a second flange extending therefrom substantially radially;
first and second mounting tabs extending outwardly from one of the first and second flanges wherein the first mounting tab defines a journal providing a bearing surface adapted to support a shaft and the second mounting tab defines mounting holes adapted to support an accessory.

11. The clutch of claim 10, further comprising:
at least one additional mounting tab extending outwardly substantially radially proximate an end of the clutch.

12. The clutch of claim 10 wherein the clutch is adapted to couple to first and second powertrains and the clutch selectively couples the first powerplant with the second powerplant.

13. A powertrain system, comprising:
a first powerplant;
a second powerplant;
a clutch coupled between the first powerplant and the second powerplant; and
a plurality of mounting tabs extending outwardly substantially in a radial direction from a housing of the clutch wherein a first mounting tab defines a journal providing a bearing surface to support a shaft associated with an accessory drive pulley and a second mounting tab has mounting holes to which an accessory support member is coupled.

14. The system of claim 13 wherein a clutch shaft extends axially from the clutch; an accessory drive shaft with an axis of the accessory drive shaft is substantially parallel with the central axis of the clutch; the accessory drive shaft rotates within the bearing surface in the first mounting tab; and a flexible member couples the accessory drive shaft.

15. The system of claim 14, further comprising:
a drive pulley coupled to the accessory drive shaft; and
a first accessory coupled to the second mounting tab wherein the first accessory has an accessory pulley; and
a belt coupling the drive pulley and the accessory pulley.

16. The system of claim 13 wherein the clutch has first and second selectively-coupled portions with a crankshaft of the first powerplant coupled to a shaft of the first portion of the clutch and a crankshaft of the second powerplant coupled to a shaft of the second portion of the clutch with an axis of the accessory drive shaft substantially parallel with the clutch shaft engaged with the clutch shaft and the accessory drive shaft so that the shaft of the first portion of the clutch and the accessory drive shaft rotate in a defined rotational relationship.

17. The system of claim 15 wherein the flexible member is one of a belt and a chain.

18. The system of claim 13 wherein the clutch has first and second selectively-coupled portions with a crankshaft of the first powerplant coupled to a shaft of the first portion of the clutch and a crankshaft of the second powerplant coupled to a shaft of the second portion of the clutch with an axis of the accessory drive shaft substantially parallel with the clutch shafts placed on the accessory drive shaft placed on the accessory drive shaft; and
a first flexible member engaging the shaft of the first portion of the clutch with the accessory drive shaft engaging the shaft of the second portion of the clutch with the accessory drive shaft.
